(19) United States
(12) Patent Application Publication
(10) Pub. No.: US 2009/0272017 A1
(43) Pub. Date: Nov. 5, 2009

(54) Hanging display apparatus

(76) Inventor: Dehai Wang, Tianjin (CN)

Correspondence Address: MATTHIAS SCHOLL, 14781 MEMORIAL DRIVE, SUITE 1319, HOUSTON, TX, 77079, US

(21) Appl. No.: 11/960,839

(22) Filed: Dec. 20, 2007

Related U.S. Application Data
(63) Continuation of application No. PCT/CN2006/001034, filed on May 19, 2006.

(30) Foreign Application Priority Data
Jun. 20, 2005 (CN) 200520026165.2

(51) Int. Cl. G09F 7/18

(52) U.S. Cl. 40/617

(57) ABSTRACT

Taught is a suspended display apparatus, comprising: a plurality of display boards and hanging wires, the display boards being connected to each other via the hanging wires, wherein a top edge attachment point is set at the center of gravity on the upper edge of each display board, a bottom edge attachment point is set at one end of the lower edge of each display board; and the bottom edge attachment point of the upper display board is connected with the top edge attachment point of the lower display board via the hanging wire. A hanging plate is added on each display board, and is intersected with the display board to adjust the balance and shape of the whole structure. Each display board is featured with two-dimensional picture or three-dimensional physical model, which can rotate freely in a range of 0 to 360 degrees.

### CROSS-REFERENCE TO RELATED APPLICATIONS

This application is a continuation of International Patent Application No. PCT/CN2006/001034 with an international filing date of May 19, 2006, designating the United States, now pending, and further claims priority benefits to Chinese Patent Application No. 200520026165.2, filed on Jun. 20, 2005. The contents of these specifications are incorporated herein by reference.

### BACKGROUND OF THE INVENTION

1. Field of the Invention

This invention relates to display apparatus for pictures or models, and more particularly, to a suspended display apparatus.

2. Description of Existing Technology

Display apparatus is generally used as one of the advertising mediums to publicize new products or technology.

Currently, there are many types of displays available all of which have the goal to make the advertisement novel and attractive. For example, there are stand displays, circular rotating displays, and display apparatus comprising a plurality of triangular prisms arranged in plane that can display three different pictures.

From Pat. No. 03257923.3, known is a “suspended display apparatus” wherein a conventional static display of pictures or models is extended to dynamic display. The apparatus takes advantage of a plurality of suspension rods and hanging wires. The suspension rods are connected to each other via the hanging wires. A suspending point, a support point, and a hanging point are set on the suspension rod orderly. Suspension rods are connected to each other through a suspending point on the upper suspension rod and a support point on the lower suspension rod to form a suspended structure. The objects to be displayed are hanged on the hanging point of each suspension rod. The support point of each suspension rod is disposed in the center of gravity of the suspension rod in the suspended structure.

The “suspended display apparatus” is integrated to form a cubic space structure by means of suspension rods and hanging wires. The hanging point can be hanged with a two-dimensional object such as a picture or a three-dimensional object such as product model or physical substances. The display objects and suspension rods can rotate freely in the range of 0 to 360 degrees, so that the suspended cubic space structure is in a status of dynamic suspension. The display objects wave along with the suspension rods, resulting in attractive and eye-catching display effect.

However, the suspension rods and hanging wires of the suspended display apparatus can only function for connection and supporting, and cannot be used for displaying objects themselves limiting the display area.

### SUMMARY OF THE INVENTION

It is an objective of this invention to provide a suspended display apparatus, which can display objects dynamically, has a novel and attractive shape, provides a larger display area, and can change display status randomly. The suspended display apparatus of this invention comprises a plurality of display boards and hanging wires. A top edge attachment point is set at the center of gravity on the upper edge of each display board. A bottom edge attachment point is set at one end of the lower edge of each display board. The bottom edge attachment point of the upper display board is connected with the top edge attachment point of the lower display board via a hanging wire. The display boards are connected to each other orderly via the hanging wires. The uppermost display board is hanged on a stationary object via a hanging wire at the top edge attachment point position. The lowermost display board is not attached at a bottom edge attachment point to any other display board.

In certain embodiments of this invention, the suspended display apparatus comprises a plurality of display boards, a plurality of hanging wires, and a plurality of hanging plates. A top edge attachment point is set at the center of gravity on the upper edge of each display board. A bottom edge attachment point is set at one end of the lower edge of each display board. The bottom edge attachment point of the upper display board is connected with the top edge attachment point of the lower display board via a hanging wire. The display boards are connected to each other orderly via hanging wires. The uppermost display board is hanged on a stationary object via the hanging wire at the top edge attachment point position. The lowermost display board is not attached at a bottom edge attachment point to any other display board. A hanging plate is set at the bottom edge attachment point of some or all of the display boards. The display board intersects with the hanging plate in an arbitrary angle to form an intercross structure. A bottom edge attachment point set at the center of the lower edge of the hanging plate is connected with the top edge attachment point of the next display board via a hanging wire.

In certain embodiments of this invention, the suspended display apparatus comprises a plurality of display boards, a plurality of hanging wires, and a plurality of hanging plates. A top edge attachment point is disposed at the center of gravity on the upper edge of each display board. A bottom edge attachment point is disposed at one end of the lower edge of each display board. The bottom edge attachment point of the upper display board is connected with the top edge attachment point of the lower display board via a hanging wire. The display boards are connected to each other orderly via hanging wires. The uppermost display board is hanged on a stationary object via the hanging wire at the top edge attachment point position. The lowermost display board is not attached at a bottom edge attachment point to any other board. A hanging plate is disposed at the other end of some or all of the display boards relative to the end set with a bottom edge attachment point. The display board intersects with the hanging plate in an arbitrary angle to form an intercross structure. A bottom edge attachment point disposed at the center of the lower edge of the hanging plate is connected with the top edge attachment point of the next display board via a hanging wire.

In certain embodiments of this invention, the display board is in a shape of plate or frame.

In certain embodiments of this invention, the hanging wire is in a shape of a thread, a chain, or a ring.

In certain embodiments of this invention, the top edge attachment point and bottom edge attachment point are set with suspension rings.

In certain embodiments of this invention, the top edge attachment point of each display board is disposed at the center of the gravity on the upper edge of each display board serving to form the whole display structure balancing the whole display structure.

In certain embodiments of this invention, each display board forming the suspended display apparatus is used for displaying a two-dimensional picture or a three-dimensional physical model.

When using the suspended display apparatus of this invention, a top edge attachment point is disposed at the center of gravity on the upper edge of the lowermost display board, and is connected with a hanging wire. The hanging wire is connected with the bottom edge attachment point set at one end of the lower edge of the second display board counted from bottom to top orderly. A top edge attachment point is disposed at the center of gravity on the upper edge of the second display board, and is connected with the bottom edge attachment point of the third display board. The fourth and fifth display boards are connected, and the uppermost display board is connected finally by the hanging wire. The hanging wire is then hanged on the upper stationary object so that the entire display apparatus is suspended.

When the suspended display apparatus is hanged on the upper stationary object, the hanging wire expands the display boards in air, and thus the picture or physical model carried on the display board is displayed in air.

Since the bottom edge attachment point of each display board is set at one end on the lower edge of the display board, the top edge attachment point of each display board is set at the center of gravity on the upper edge of each display board. Therefore, the various display boards connected by the hanging wire forming the display apparatus hanged on the stationary object are balanced to each other according to the mechanical principle of a lever. Each display can rotate freely in a range of 0 to 360 degrees and is thus dynamically suspended in air. The display objects wave along with the display boards, resulting in attractive and eye-catching display effect, so that the advertisement effect is enhanced.

When a new hanging plate is added at the bottom edge attachment point of each display board, the center of gravity on the lower edge of the hanging plate is the bottom edge attachment point to connect with the top edge attachment point of the next display board via the hanging wire. Based on the weight and the position on the display board, in combination with the lever mechanical principle, the weight balance of the whole display apparatus can be adjusted and the display capacity can be increased. The display board intersects with the hanging plate at an arbitrary angle to form an intercross structure, enhancing the suspending and waving effect of the display.

Since the display boards function not only as connection components but also as display components, the display area of the display apparatus is increased compared with conventional display apparatuses.

According to this invention, the display content is changed merely by changing the content on the display board or by replacing the display board; it is simple and convenient. The display area can also be changed by adjusting the size and quantity of the display boards from bottom to top.

As a result, the suspended display apparatus of this invention displays objects dynamically, has a novel and attractive shape, provides a larger display area, and changes display status randomly.

### BRIEF DESCRIPTION OF THE DRAWINGS

FIG. 1 illustrates a front elevational view of a suspended display apparatus according to one embodiment of the invention;

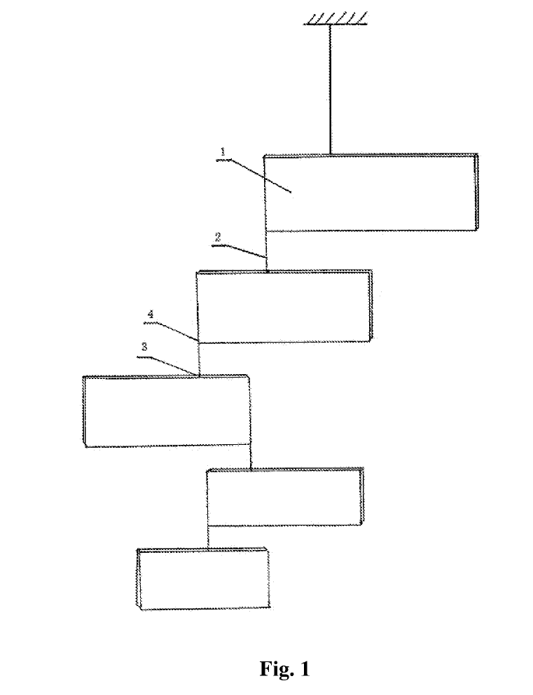

FIG. 2 illustrates a perspective view of a suspended display apparatus according to one embodiment of the invention; and

FIG. 3 illustrates a perspective view of a suspended display apparatus according to another embodiment of the invention.

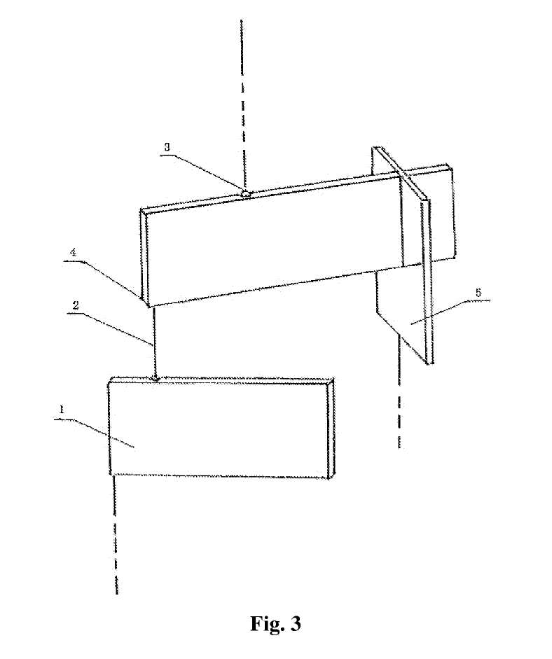

The reference numbers of the various parts shown in the drawings are listed below, in which display board corresponds to the number 1; hanging wire—2; top edge attachment point—3; bottom edge attachment point—4; and hanging plate—5.

### DETAILED DESCRIPTION OF THE EMBODIMENTS

### Example 1

A set of rectangular display boards 1 was made using polyester laminate In bottom to up order, the dimensions (length×height) of the lowermost, second, third, forth, and the uppermost display boards were 60×30 cm, 70×30 cm, 80×40 cm, 80×40 cm, and 90×40 cm, respectively. The hanging wire 2 was a colored metal chain.

The top edge attachment point 3 of the lowermost display board 1 was disposed at the center of the upper edge of the display board 1, namely, the distance of the top edge attachment point 3 to each end of the display board was 30 cm.

The bottom edge attachment point 4 of the second display board 1 was disposed at the left end of the lower edge of the second display board 1. The top edge attachment point 3 was disposed on the upper edge of the second display board 1, and its distance to the left end of the display board 1 was 20 cm.

The bottom edge attachment point 4 of the third display board 1 was disposed at the right end of the lower edge of the third display board 1. The top edge attachment point 3 was set on the upper edge of the display board 1, and its distance to the right end of the display board 1 was 20 cm.

The bottom edge attachment point 4 of the fourth display board 1 was disposed at the left end of the lower edge of the fourth display board 1. The top edge attachment point 3 was set on the upper edge of the display board 1, and its distance to the left end of the display board 1 was 15 cm.

The bottom edge attachment point 4 of the fifth display board 1 was disposed at the left end of the lower edge of the fifth display board 1. The top edge attachment point 3 was set on the upper edge of the display board 1, and its distance to the left end of the display board 1 was 20 cm.

When using the suspended display apparatus of this invention for vehicle display, both surfaces of the display board 1 were painted with promotion patterns or allowed to carry vehicle models. The uppermost display board 1 was hanged on the ceiling of the exhibition hall via the hanging wire 2 at the top edge attachment point 3. Since the hanging wire 2 was connected dynamically with the display board 1, the display board 1 carrying vehicle patterns or models was suspended in air, resulting in a novel and attractive display effect.

### Example 2

Multiple semi-transparent rectangular display boards 1 were prepared using steel rectangular frames with silk strained thereon. A circular semi-transparent hanging plate 5 made of steel circular frame with silk strained thereon was disposed at one end of the bottom edge attachment point 4 of each display board, and was vertical to the display board. The hanging plate 5 and the display board 1 formed a perpendicular intercross structure at one end of the bottom edge attachment point 4. The bottom edge attachment point 4 was disposed at the center of gravity on the lower edge of each hanging plate 5, namely, at the lowermost point of the circle, and was connected with the lower display board 1 via the hanging wire 2.

In bottom to top order, the dimension (length×height) of the lowermost, second, third, forth, and the uppermost display boards 1 were 10×3 cm, 15×5 cm, 18×5 cm, 20×5 cm, and 28×10 cm, respectively.

In bottom to top order, the diameters () of the lowermost, second, third, forth, and the uppermost display boards were 6 cm, 10 cm, 10 cm, 10 cm, and 20 cm, respectively.

Using colored silk wire as the hanging wire, each wire was 5 cm long.

The top edge attachment point 3 of the lowermost display board 1 was disposed at the center of the upper edge of the display board 1, namely, the distance of the top edge attachment point 3 to the both ends of the display board was 5 cm.

The bottom edge attachment point 4 of the second display board 1 was disposed at the left end of the lower edge of the second display board 1. The top edge attachment point 3 was disposed on the upper edge of the second display board 1, and its distance to the left end of the display board 1 was 5 cm. The circular hanging plate 5 was disposed at the bottom edge attachment point 4 of the display board 1, and was perpendicularly intersected with the display board 1. A bottom edge attachment point 4 was disposed at the lowermost position of the lower edge of the circular hanging plate 5, and was connected with the top edge attachment point 3 of the lower first display board 1 via a hanging wire 2.

The bottom edge attachment point 4 of the third display board 1 was disposed at the right end of the lower edge of the third display board 1. The top edge attachment point 3 was disposed on the upper edge of the display board 1, and its distance to the right end of the display board 1 was 5 cm. The circular hanging plate 5 was disposed at the bottom edge attachment point 4 of the display board 1, and was perpendicular intersected with the display board 1. A bottom edge attachment point 4 was disposed at the lowermost position of the lower edge of the circular hanging plate 5, and was connected with the top edge attachment point 3 of the lower second display board 1 via a hanging wire 2.

The bottom edge attachment point 4 of the forth display board 1 was disposed at the left end of the lower edge of the forth display board 1. The top edge attachment point 3 was disposed on the upper edge of the display board 1, and its distance to the left end of the display board 1 was 4 cm. The circular hanging plate 5 was disposed at the bottom edge attachment point 4 of the display board 1, and was perpendicularly intersected with the display board 1. A bottom edge attachment point 4 was disposed at the lowermost position of the lower edge of the circular hanging plate 5, and was connected with the top edge attachment point 3 of the lower third display board 1 via a hanging wire 2.

The bottom edge attachment point 4 of the fifth display board 1 was disposed at the left end of the lower edge of the fifth display board 1. The top edge attachment point 3 was disposed on the upper edge of the display board 1, and its distance to the right end of the display board 1 was 3 cm, and was perpendicularly intersected with the display board 1. A bottom edge attachment point 4 was disposed at the lowermost position of the lower edge of the circular hanging plate 5, and was connected with the top edge attachment point 3 of the lower forth display board 1 via a hanging wire 2.

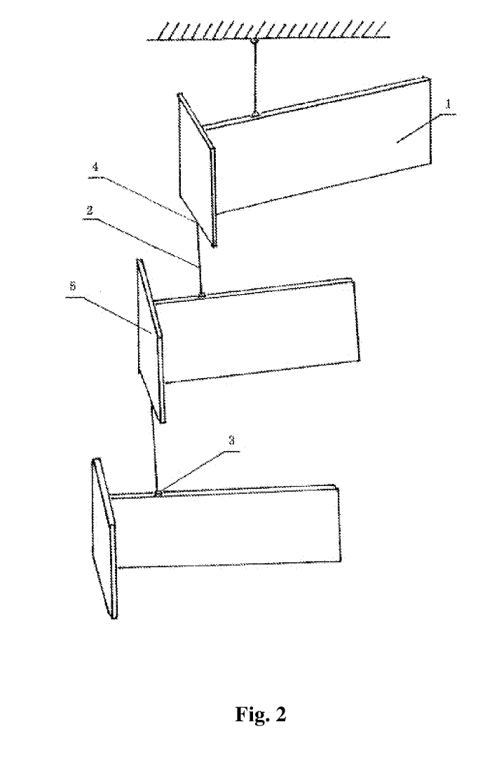

The hanging wire 2 connected the top edge attachment point 3 of the fifth display board to a hook attached to a 1 meter high vertical column stand, as shown in FIG. 2.

When using the suspended display apparatus of this invention for a toy display, the display board 1 and the hanging plate 5 can be featured with toy patterns and three-dimensional physical toys. The suspending rotatable patterns and the three-dimensional physical toys can attract much more interest from children, resulting in a better advertising effect.

### Example 3

Hanging the circular hanging plate 5 of the fifth display board 1 in Example 2 on the other end of the bottom edge attachment point 4 of the fifth display board 1, the hanging plate 5 was perpendicularly intersected with the fifth display board 1. A top edge attachment point 4 was disposed at the lowermost position of the circular hanging plate 5, and was connected with the hanging wire 2. The lower end of the hanging wire 2 was connected with the top of another circular hanging plate 5. The circular hanging plate 5 can not only increase the display area, but also serves to adjust the balance of the entire structure.

1. A suspended display apparatus, comprising: a plurality of display boards and hanging wires, wherein a top edge attachment point is disposed at the center of gravity on an upper edge of each display board; a bottom edge attachment point is disposed at one end on a lower edge of each display board; the bottom edge attachment point of an upper display board is connected with the top edge attachment point of a lower display board via a hanging wire; the display boards are connected to each other orderly via a hanging wire; an uppermost display board is hanged on a stationary object via a hanging wire attached to the top edge attachment point; and the lowermost display board is not attached at its bottom edge to any other display board.

2. A suspended display apparatus, comprising: a plurality of display boards, a plurality of hanging wires, and a plurality of hanging plates, wherein a top edge attachment point is disposed at the center of gravity on an upper edge of each display board; a bottom edge attachment point is disposed at one end on a lower edge of each display board; the bottom edge attachment point of an upper display board is connected with the top edge attachment point of a lower display board via a hanging wire; the display boards are connected to each other orderly via hanging wires; an uppermost display board is hanged on a stationary object via a hanging wire at its top edge attachment point; a lowermost display board is not attached at its bottom edge to any other display board; a hanging plate is disposed at the bottom edge attachment point on the lower edge of some or all of the display boards; the display board intersects with the hanging plate at an arbitrary angle to form an intercross structure; a bottom edge attachment point disposed at the center of the lower edge of the hanging plate is connected with the top edge attachment point of the lower next display board via a hanging wire.

3. A suspended display apparatus, comprising: a plurality of display boards, a plurality of hanging wires, and a plurality of hanging plates, wherein a top edge attachment point is disposed at the center of gravity on an upper edge of each display board; a bottom edge attachment point is disposed at one end on a lower edge of each display board; the bottom edge attachment point of an upper display board is connected with the top edge attachment point of a lower display board via a hanging wire; the display boards are connected to each other orderly via a hanging wire; an uppermost display board is hanged on a stationary object via a hanging wire at its top edge attachment point; a lowermost display board is not attached at the bottom edge to any other display board; a hanging plate is disposed at the other end of some or all of the display boards relative to the end set with a bottom edge attachment point; and the display board intersects with the hanging plate at an arbitrary angle to form an intercross structure.

4. The suspended display apparatus of claim 3, wherein a bottom edge attachment point set at the center of the lower edge of the hanging plate is connected with the top edge attachment point of the next display board via a hanging wire.
